(19) United States
(12) Patent Application Publication
(10) Pub. No.: US 2011/0314821 A1
(43) Pub. Date: Dec. 29, 2011

(54) Flow-Through Substrates and Methods for Making and Using Them

(76) Inventors: Dana Craig Bookbinder, Corning, NY (US); Kishor Purushottam Gadlkaree, Painted Post, NY (US); Paul John Shustack, Elmira, NY (US); Shaole Wu, San Jose, CA (US)

(21) Appl. No.: 13/139,405

(22) PCT Filed: Dec. 18, 2009
(86) PCT No.: PCT/US09/68706

§ 371 Date: Jun. 13, 2011

Related U.S. Application Data
(60) Provisional application No. 61/139,097, filed on Dec. 19, 2008.

(51) Int. Cl. F01B 31/16; B01J 20/22; B01J 20/02; B29C 47/00; B01J 20/28; B01J 20/30; B01D 53/04; B01J 20/26; B01J 20/06

(52) U.S. Cl. 60/694; 502/402; 502/401; 502/400; 95/133; 95/134; 264/177.12

(57) ABSTRACT

A flow-through substrate comprising a sulfur-containing compound distributed throughout the flow-through substrate structure. The flow-through substrate may be used, for example, in the removal of a heavy metal from a fluid such as a gas stream.

This application claims the benefit of, and priority to U.S. Provisional Patent Application No. 61/139,097 filed on Dec. 19, 2008 entitled, “Flow-Through Substrates and Methods for Making and Using Them”, the content of which is relied upon and incorporated herein by reference in its entirety.

### FIELD OF THE INVENTION

This disclosure relates to a flow-through substrate, such as a honeycomb, useful, for example, in the removal of a heavy metal from a fluid.

### BACKGROUND

Emissions of heavy metals have become environmental issues of increasing importance because of the potential dangers to human health. During coal and municipal solid waste combustion, for instance, some heavy metals are transferred into the vapor phase due to their high volatility. Once discharged to the atmosphere, heavy metals may persist in the environment and create long-term contamination.

Many currently proposed pollution abatement technologies are not capable of effectively controlling gas phase emissions of heavy metals, particularly from flue gas emissions in the utility industry. For example mercury emission control technologies such as adsorption using various absorbents, direct carbon injection, flue gas desulfurization technologies (FGD), wet scrubbers, wet filtration, etc. are still limited to research stages.

### SUMMARY

The present inventors have now made new materials useful, for example, for the capture of heavy metals from fluids. Embodiments of the invention relate to a flow-through substrate, such as a honeycomb, comprising a sulfur-containing compound distributed throughout the flow-through substrate structure. The flow-through substrate may be used, for example, in the removal of a heavy metal from a fluid such as a gas stream.

### DESCRIPTION OF THE EMBODIMENTS

A first embodiment of the invention is a flow-through substrate, such as a honeycomb, which comprises a sulfur-containing compound distributed throughout the flow-through substrate structure, wherein the sulfur-containing compound is selected from a non-elemental and non-metal sulfide sulfur compound; a polysulfide; and an organic mono- or polysulfide; wherein the flow-through substrate is essentially free of activated carbon; and wherein the flow-through substrate structure comprises at least 50 wt % of glass, ceramic, inorganic cement, or glass-ceramic.

A second embodiment of the invention is a flow-through substrate, such as a honeycomb, which comprises a sulfur-containing compound distributed throughout the flow-through substrate structure; wherein the sulfur-containing compound is selected from a metal polysulfide and an organic mono- or polysulfide.

A third embodiment of the invention is a flow-through substrate, such as a honeycomb, which comprises a sulfur-containing compound distributed throughout the flow-through substrate structure; wherein the flow-through substrate comprises no metal monosulfide, or, comprises less than 30 wt % metal monosulfide; wherein the flow-through substrate is essentially free of activated carbon; and wherein the flow-through substrate structure comprises at least 50 wt % of glass, ceramic, inorganic cement, or glass ceramic.

The term “flow-through substrate” as used herein is a shaped body comprising inner passageways, such as straight or serpentine channels and/or porous networks that would permit the flow of a fluid stream through the body. The flow-through substrate comprises a dimension in the flow-through direction of at least 1 cm, at least 2 cm, at least 3 cm, at least 4 cm, at least 5 cm, at least 6 cm at least 7 cm, at least 8 cm, at least 9 cm, or at least 10 cm from the inlet to the outlet.

In one embodiment, the flow-through substrate comprises a reticulated or open cell ceramic foam.

In one embodiment, the flow-through substrate has a honeycomb structure comprising an inlet end, an outlet end, and inner channels extending from the inlet end to the outlet end. In one embodiment, the honeycomb comprises a multiplicity of cells extending from the inlet end to the outlet end, the cells being defined by intersecting cell walls. The honeycomb substrate could optionally comprise one or more selectively plugged honeycomb substrate cell ends to provide a wall flow-through structure that allows for more intimate contact between the fluid stream and cell walls.

Flow-through substrates in some embodiments of the invention comprise at least 50 wt % glass, ceramic, inorganic cement or glass-ceramic. Some examples of such materials include cordierite, mullite, clay, magnesia, metal oxides, talc, zircon, zirconia, zirconates, zirconia-spinel, magnesium alumino-silicates, spinel, zeolite, alumina, silica, silicates, borides, alumina-titanate, alumino-silicates, e.g., porcelains, lithium aluminosilicates, alumina silica, feldspar, titania, fused silica, nitrides, borides, carbides, (e.g., silicon carbide), silicon nitride, and metal oxides, metal sulfates, metal carbonates or metal phosphates, wherein the metal can be for example Ca, Mg, Al, B, Fe, Ti, Zn, or combinations of these. In other embodiments, the flow-through substrates comprise at least 60 wt %, at least 70 wt %, at least 80 wt %, at least 90 wt %, or at least 95 wt % of glass, ceramic, inorganic cement or glass-ceramic.

Additional examples of inorganic cements include Portland cement blends, for example Portland blastfurnace cement, Portland flyash cement, Portland pozzolan cement, Portland silica fume cement, masonry cements, expansive cements, white blended cements, colored cements, or very finely ground cements; or non-Portland hydraulic cements, for example pozzolan-lime cements, slag-lime cements, supersulfated cements, calcium aluminate cements, calcium sulfoaluminate cements, natural cements, or geopolymer cements.

Flow-through substrates in some embodiments of the invention comprise a polymer. The polymer may be linear or cross-linked and may include, for example, organic polymers, such as epoxies, polyamides, polyimides or phenolic resins, or silicone polymers, such as methyl or phenyl silicones, and combinations thereof.

In some embodiments, the flow-through substrate may comprise fibrous fillers, for example, ceramic, glass or metal fibers or whiskers.

In one embodiment, the flow-through substrate comprises a surface having a surface area of 100 m²/g or more, 200 m²/g or more, 300 m²/g or more, 400 m²/g or more, or 500 m²/g or more.

Embodiments of the invention comprise a sulfur-containing compound distributed throughout the flow-through substrate structure. The sulfur-containing compound “distributed throughout the flow-through substrate” is intimately embedded within the substrate structure, as opposed to only disposed on exposed surfaces of the substrate. Thus, within a honeycomb structure comprising a plurality of cells defined by porous cell walls, the sulfur-containing compound is present within the cell walls (not only on the channel wall surfaces) and present within the structures defining the pores (not only on exposed pore surfaces).

In embodiments where the flow-through substrate comprises a non-elemental and non metal sulfide, such sulfur-containing compounds include, for example, sulfites and sulfates, organic compounds comprising sulfur, including sulfur containing organosilanes, alkylpolysulfides, aromaticpolysulfides, polythioacetals, sulfonium polymers, polythioesters, polythiocarbonates, polyazothiones, thiazo polymers, polymers containing sulfur-phosphorous linkages, polysulfoxides, polysulfones, poly(sulfonic acids) and their derivatives, and organometallic polymers containing sulfur.

In embodiments where the flow-through substrate comprises a metal polysulfide, such sulfur-containing compounds include sulfur cements and polysulfides of transition metals such as iron, manganese, molybdenum, copper, and zinc.

In embodiments where the flow-through substrate comprises an organic mono- or polysulfide, such sulfur-containing compounds include thio-carbamates, thio-cyanurates, cysteine, cystine, mercaptosuccinic acid, polydisulfides, polythiols and polymonosulfides. Organic mono- and polysulfides include silicon and silane containing organic compounds, for example, (3-mercaptopropyl)trimethoxy silane, bis[3-(triethoxysilyl)propyl]-disulfide, bis[3-(triethoxysilyl)propyl]-tetrasulfide and bis-alkoxysilylpropyl polysulfides, and their corresponding sulfur-containing silicone polymers.

The flow-through substrate may further comprise any other suitable materials in addition to the sulfur-containing compound. For instance, the flow-through substrate may comprise sulfur in addition to that present in the sulfur-containing compound described above. The additional sulfur may include sulfur at any oxidation state, including elemental sulfur (0), sulfate (+6), sulfite (+4), and sulfide (−2). This includes sulfur powder, sulfur-containing powdered resin, sulfides, sulfates, and other sulfur-containing compounds, and combination of any two or more of these. Exemplary sulfur-containing compounds include hydrogen sulfide and/or its salts, carbon disulfide, sulfur dioxide, thiophene, sulfur anhydride, sulfur halides, sulfuric ester, sulfurous acid, sulfacid, sulfatol, sulfamic acid, sulfan, sulfanes, sulfuric acid and its salts, sulfite, sulfoacid, sulfobenzide, sulfur containing organosilanes and combinations thereof.

In embodiments where the sulfur-containing compound comprises a metal mono- or polysulfide, the metal may include, for example, alkali metal, alkaline earth metals, and transition metals. In some embodiments, the flow-through substrate does not comprise a metal monosulfide, or comprises less than 30 wt % metal monosulfide.

In some embodiments, the flow-through substrate comprises at least 0.5 wt % of sulfur-containing compound, such as at least 1.0 wt % of sulfur-containing compound, at least 5.0 wt % of sulfur-containing compound, or at least 10 wt % of sulfur-containing compound.

In some embodiments, at least a portion of the sulfur-containing compound is chemically bound to at least a portion of flow-through substrate structure. The term “at least a portion” in this and other contexts refers to some or all of the material being described. Thus, in these embodiments, some or all of the sulfur-containing compound can be chemically bound to some or all of the flow-through substrate.

The sulfur-containing compound itself may comprise a defined surface area, such as a surface area ranging from 0.01 m²/g to 500 m²/g. In some embodiments, the sulfur-containing compound has a surface area of 300 m²/g or less, 200 m²/g or less, 100 m²/g or less, 50 m²/g or less, 10 m²/g or less, or 5 m²/g or less.

In some embodiments, the flow-through substrate is essentially free of activated carbon. In some of those embodiments, the flow-through substrate comprises no activated carbon. In other of those embodiments the flow-through substrate comprises less than 10%, less than 5%, less than 3%, less than 1%, or less than 0.1% by weight of activated carbon.

The flow-through substrate may be made by any suitable technique. In one embodiment, the flow-through substrate may be made by a method which comprises mixing the sulfur-containing compound with batch mixture material to provide a sulfur compound-containing batch mixture; and forming the sulfur compound-containing batch mixture into a flow-through substrate. Example flow-through substrates are disclosed in U.S. Pat. Nos. 3,885,977 and 3,790,654, the contents of both being incorporated by reference herein.

The batch mixture material can be comprised, for example, of a combination of inorganic batch materials including, for example, a predominant sintered phase composition comprised of ceramic, glass-ceramic, glass and combinations thereof. It should be understood that, as used herein, combinations of glass, ceramic, and/or glass ceramic compositions includes both physical and/or chemical combinations, e.g., mixtures or composites. Example batch mixture materials include, for example, glass, glass-ceramic, ceramic, or inorganic cement materials mentioned above in the context of the composition of the flow-through substrate. In some embodiments the batch mixture may comprise oxide glass; oxide ceramics; or other refractory materials. Exemplary and non-limiting inorganic materials suitable for use in an inorganic batch mixture can include oxygen-containing minerals or salts, clay, zeolites, talc, cordierite, titanates, aluminum titanate, mullite, magnesium oxide sources, zircon, zirconates, zirconia, zirconia spinel, spinel, alumina forming sources, including aluminas and their precursors, silica forming sources, including silicas and their precursors, silicates, aluminates, aluminosilicates, kaolin, flyash, lithium aluminosilicates, alumina silica, aluminosilicate fibers, magnesium aluminum silicates, alumina trihydrate, feldspar, boehmite, attapulgites, titania, fused silica, nitrides, carbides, carbonates, borides, (e.g. silicon carbide, silicon nitride), or combinations of these.

It should be understood that the inorganic batch mixture can further comprise one or more additive components. In one embodiment, the inorganic batch mixture can comprise an inorganic binder, such as for example, a borosilicate glass.

The binder component can include organic binders, inorganic binders, or a combination of both. Suitable organic binders include water soluble cellulose ether binders such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, methylcellulose derivatives, hydroxyethyl acrylate, polyvinylalcohol, and combinations thereof.

One liquid vehicle for providing a flowable or paste-like consistency to the batch mixture is water, although it should be understood that other liquid vehicles exhibiting solvent action with respect to suitable temporary organic binders could be used. The amount of the liquid vehicle component can vary in order to impart optimum handling properties and compatibility with other components in the batch mixture.

In addition to a liquid vehicle and binder, the batch mixture can also comprise one or more optional forming or processing aids. Exemplary forming or processing aids or additives can include lubricants, ionic surfactants, plasticizers, and sintering aids. Exemplary lubricants can include hydrocarbon acids, such as, stearic acid or oleic acid, sodium stearate, petroleum oils with molecular weights from about 250 to 1000, containing paraffinic and/or aromatic and/or alicyclic compounds. Other useful oils are 3 in 1 oil from 3M Co., or 3 in 1 household oil from Reckitt and Coleman Inc., Wayne, N.J., synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, soybean oil etc. are also useful. An exemplary plasticizer can include glycerine.

The batch mixture may further comprise any other suitable materials in addition to the sulfur-containing compound. For instance, the batch mixture may comprise sulfur in addition to that present in the sulfur-containing compound. The additional sulfur may include sulfur at any oxidation state, including elemental sulfur (0), sulfate (+6), sulfite (+4) and sulfide (−2).

In another embodiment, the flow-through substrate can be made through reduction of a sulfur compound. For example, the flow-through substrate may comprise sulfur at an oxidation state of greater than 0 (for example, a sulfite or sulfate), then exposed to a reducing atmosphere (for example H₂ or CO) to reduce the sulfur compound and result in a flow-through substrate of the invention.

The batch mixture, for example, can be formed into the shape of a honeycomb by any appropriate technique, such as by extrusion. Extrusion can be done by using standard extruders (ram extruder, single-screw, double-screw, and the like) and custom extrusion dies, to make honeycombs with various shapes and geometries.

The shaped structure can then be dried, for example, by heating. In some embodiments, the shaped structure can be dried by heating to a temperature up to 200° C., up to 300° C., or up to 400° C.

The flow-through substrates of the invention, such as honeycombs, may be used, for example, for the sorption of any contaminant from a fluid through contact with the fluid. For example, a fluid stream may be passed through inner passageways of a flow-through substrate from the inlet end to the outlet end. The fluid stream may be in the form of a gas or a liquid. The gas or liquid may also contain another phase, such as a solid particulate in either a gas or liquid stream, or droplets of liquid in a gas stream. Example gas streams include coal combustion flue gases (such as from bituminous and sub-bituminous coal types or lignite coal) and syngas streams produced in a coal gasification process.

The terms “sorb,” “sorption,” and “sorbed,” refer to the adsorption, absorption, or other entrapment of the contaminant on the flow-through substrate, either physically, chemically, or both physically and chemically.

Contaminants to be sorbed include, for instance, contaminants at 3 wt % or less within the fluid stream, for example at 2 wt % or less, or 1 wt % or less. Contaminants may also include, for instance, contaminants at 10,000 μg/m³ or less within the fluid stream. Example contaminants include heavy metals. The term “heavy metal” and any reference to a particular metal by name herein includes the elemental forms as well as oxidation states of the metal. Sorption of a metal thus includes sorption of the elemental form of the metal as well as sorption of any organic or inorganic compound or composition comprising the metal.

Example heavy metals that can be sorbed include cadmium, mercury, chromium, lead, barium, beryllium, and chemical compounds or compositions comprising those elements. For example, the metal mercury may be in an elemental) (Hg⁰) or oxidized state (Hg⁺ or Hg²⁺). Example forms of oxidized mercury include HgO and halogenated mercury, for example Hg₂Cl₂ and HgCl₂. Other exemplary metallic contaminants include nickel, cobalt, vanadium, zinc, copper, manganese, antimony, silver, and thallium, as well as organic or inorganic compounds or compositions comprising them. Additional contaminants include arsenic and selenium as elements and in any oxidation states, including organic or inorganic compounds or compositions comprising arsenic or selenium.

The contaminant, such as a heavy metal, may be in any phase that can be sorbed on the flow-through substrate. Thus, the contaminant may be present, for example, as a liquid in a gas fluid steam, or as a liquid in a liquid fluid stream. The contaminant could alternatively be present as a gas phase contaminant in a gas or liquid fluid stream.

Any flow-through substrates of the invention, such as honeycombs, may be incorporated into or used in any appropriate system environments. For example, on embodiment of the invention is a power plant comprising one or more of the flow-through substrates disclosed herein, a coal combustion or coal gasification unit and a passageway adapted to convey a coal combustion flue gas or syngas from the coal combustion or gasification unit to the flow-through substrate.

### EXAMPLES

### Examples 1-14

### Hg²⁺ Sorption (Hg²⁺ (OAc)₂+Sulfur-Containing Compound)

Sulfur-containing compounds along with control samples which did not contain sulfur compounds were tested for sorption of mercury ions are shown in Table 1. The materials were prepared as follows: The material (Compound 1) for Example 1 did not contain a sulfur compound and was silica gel (Davisil-646, 150 angstrom, 35-60 mesh, purchased from Sigma-Aldrich Corporation, Milwaukee, Wis., product code 23684-5). The material (Compound 2) for Example 2 did not contain a sulfur compound and was molecular sieves 13× (zeolite, sodium X-zeolite with faujasite structure having a silica to alumina ration of 2), 2 micron powder (purchased from Sigma-Aldrich Corporation, product code 28359-2).

The material (Compound 3) for Example 3 was prepared by coating 10 grams of silica gel (described in Example 1) with 6 grams of (3-mercaptopropyl)trimethoxy silane (Sigma-Aldrich product code 17561-7) in 20 grams of methanol plus 1 gram of dI (deionized) water plus 1 gram of acetic acid. The coating reaction was allowed to proceed for 24 hours with stirring. The mercaptosilane coated silica gel was filtered and rinsed with methanol then dried at about 140° C. for 12 hours.

The material (Compound 4) for Example 4 was prepared by coating 10 grams of molecular sieve powder (described in Example 2) with 6 grams of (3-mercaptopropyl)trimethoxy silane (Sigma-Aldrich product code 17561-7) in 20 grams of methanol plus 1 gram of dI water plus 1 gram of acetic acid. The coating reaction was allowed to proceed for 24 hours with stirring. The mercaptosilane coated molecular sieve was filtered and rinsed with methanol then dried at about 140° C. for 12 hours.

The material (Compound 5) for Example 5 [Fe₂S₃ nano-colloid] was prepared by dissolving 5 grams of Na₂S-9H₂O (Sigma-Aldrich product code 20804-3) in 100 grams of dI water then while mixing using an ultrasonic bath adding a solution of 3.5 grams of Fe₂(SO₄)₃-xH₂O (Sigma-Aldrich product code 30771-8) in 100 grams of dI water. The pH of the Fe₂S₃ nano-colloid suspension was adjusted to 10 by adding a small amount of 5 weight % KOH in water. The solution was filtered and the Fe₂S₃ nano-colloid powder was rinsed with dI water then dried at about 140° C. for about 3 hours.

The material (Compound 6) for Example 6 [FeS nano-colloid] was prepared by dissolving 5 grams of Na₂S-9H₂O (Sigma-Aldrich product code 20804-3) in 100 grams of dI water then while mixing using an ultrasonic bath adding a solution of 9.0 grams of (NH₄)₂Fe(SO₄)₂-6H₂O (Sigma-Aldrich product code 21540-6) in 100 grams of dI water. The pH of the FeS nano-colloid suspension was adjusted to 9 by adding a small amount of 5 weight % KOH in water. The solution was filtered and the FeS nano-colloid powder was rinsed with dI water then dried about 140° C. for about 3 hours.

The material (Compound 7) for Example 7 [MnS nano-colloid] was prepared by dissolving 10 grams of Na₂S-9H₂O (Sigma-Aldrich product code 20804-3) in 100 grams of dI water then while mixing using an ultrasonic bath adding a solution of 9.1 grams of MnCl₂-4H₂O (Sigma-Aldrich product code 22127-9) in 100 grams of dI water. The pH of the MnS nano-colloid suspension was adjusted to 11 by adding a small amount of 5 weight % KOH in water. The solution was filtered and the MnS nano-colloid powder was rinsed with dI water then dried at about 140° C. for about 3 hours.

The material (Compound 8) for Example 8 [Mn(S₄), manganese tetrasulfide, nano-colloid] was prepared by first reacting 5 grams of Na₂S-9H₂O with 2 grams of elemental sulfur (Sigma-Aldrich product code 21523-6) plus 50 ml of dI H₂O and stirring at approximately 22° C. for 12 hours in order to produce Na₂(S₄) in solution. 4 grams of MnCl₂-4H₂O was dissolved in 50 ml of dI H₂O then added to the Na₂(S₄) solution while mixing using an ultrasonic bath to produce Mn(S₄) nano-colloid suspension. The pH of the Mn(S₄) nano-colloid suspension was adjusted to 11 by adding a small amount of 5 weight % KOH in water. The solution was filtered and the Mn(S₄) nano-colloid powder was rinsed with dI water then dried at about 140° C. for about 3 hours.

The material (Compound 9) for Example 9 [Fe(S₄), iron tetrasulfide, nano-colloid] was prepared by first reacting 5 grams of Na₂S-9H₂O with 2 grams of elemental sulfur (Sigma-Aldrich product code 21523-6) plus 50 ml of dI H₂O and stirring at approximately 22° C. for 12 hours in order to produce Na₂(S₄) in solution. 7.9 grams of (NH₄)₂Fe(SO₄)₂₋₆H₂O was dissolved in 50 ml of dI H₂O then added to the Na₂(S₄) solution while mixing using an ultrasonic bath to produce Fe(S₄) nano-colloid suspension. The pH of the Fe(S₄) nano-colloid suspension was adjusted to 11 by adding a small amount of 5 weight % KOH in water. The solution was filtered and the Fe(S₄) nano-colloid powder was rinsed with dI water then dried at about 140° C. for about 3 hours.

The material (Compound 10) for Example 10 [Mn(trithiocyanuric acid) nano-colloid] was prepared by first dissolving 10 grams of trithiocyanuric acid, trisodium salt nonahydrate (Sigma-Aldrich product code 38292-2) plus 100 ml of dI H₂O. 8 grams of MnCl₂-4H₂O was dissolved in 100 ml of dI H₂O then added to the trithiocyanuric acid, trisodium salt solution while mixing using an ultrasonic bath to produce Mn(trithiocyanuric acid) nano-colloid suspension. The pH of the Mn(trithiocyanuric acid) nano-colloid suspension was adjusted to 10 by adding a small amount of 5 weight % KOH in water. The solution was filtered and the Mn(trithiocyanuric acid) nano-colloid powder was rinsed with dI water then dried at about 140° C. for about 3 hours.

The material (Compound 11) for Example 11 [Mn(dimethyldithiocarbamate) nano-colloid] was prepared by first dissolving 10 grams of sodium dimethyldithiocarbamate hydrate (Sigma-Aldrich product code D15660-4) plus 100 ml of dI H₂O. 5.5 grams of MnCl₂-4H₂O was dissolved in 100 ml of dI H₂O then added to the sodium dimethyldithiocarbamate solution while mixing using an ultrasonic bath to produce Mn(dimethyldithiocarbamate) nano-colloid suspension. The pH of the Mn(dimethyldithiocarbamate) nano-colloid suspension was adjusted to 11 by adding a small amount of 5 weight % KOH in water. The solution was filtered and the Mn(dimethyldithiocarbamate) nano-colloid powder was rinsed with dI water then dried at about 140° C. for about 3 hours.

The material (Compound 12) for Example 12 [1-cysteine] was purchased from Sigma-Aldrich Corporation, product code 16814-9.

The material (Compound 13) for Example 13 [1-cystine] was purchased from Sigma-Aldrich Corporation, product code C12200-9.

The material (Compound 14) for Example 14 [2-mercaptonicotinic acid] was purchased from Sigma-Aldrich Corporation, product code 41970-2.

Testing of the materials for Examples 1-14 was done as follows: A 7.8 weight percent mercury acetate [Hg(OAc)₂, Sigma-Aldrich, product code 45601-2] solution was prepared in dI water containing 1 weight percent acetic acid. Approximately 0.2 grams of each material described above for Examples 1-14 was placed in a 50 ml test tube along with 16 ml of the mercury acetate solution (the source of Hg²⁺ ions). The test tubes were capped, placed in an ultrasonic bath for 3 hours at approximately 50° C., then placed on a rocker table for an additional 16 hours in order to expose the sample to mercury ions. Each sample was then centrifuged at 4000 RPM, and the solution was decanted from the solids. Then the solids were re-suspended in 40 ml of dI water in order to rinse out the unreacted mercury ions, placed back in the ultrasonic bath at room temperature (approximately 22° C.) for 30 minutes, centrifuged again and decanted. The dI rinsing process was repeated 5 times to remove any unreacted mercury ions. The solids (herein called Hg:compound adduct) from each of the Examples 1-14 were then dried for approximately 12-18 hours in a vacuum oven set at approximately 95° C.

The samples were then characterized by ICP-MS (inductively coupled plasma mass spectrometry) to determine the amount of Hg sorption with each of the materials tested; results are reported in mg of Hg detected per gram of solid Hg:compound adduct. The initial powders (before exposure to Hg) were also characterized by BET-nitrogen absorption using a Micromeritics Tristar 3000 (Micromeritics Instrument Corporation, Norcross, Ga.) to determine their surface area. The results are shown in Table 1.

The results show almost no sorption of mercury to the control samples Compounds 1 and 2 (0.20-0.45 mg Hg/g Hg:compound adduct). The results also show very high sorption of mercury to all of the compounds comprising sulfur (Compounds 3-14); the samples adsorbed between 92 to 864 mg of Hg per gram of Hg:compound adduct. The sulfur-containing also can be made with a large surface area of 0.7 m²/g to greater than 200 m²/g. The sulfur-containing compounds disclosed herein may, in accordance with the invention, be distributed throughout a flow-through substrate, such as a honeycomb, which may be used for the capture of heavy metals such as mercury.

TABLE 1
Sulfur-containing compounds tested for Hg²⁺ sorption

| | | | Mercury Adsorbed, |
|---|---|---|---|
| | | Compound Surface | (Hg)/(Hg:compound |
| Example | Compound | Area, m2/gram | adduct), mg/g |
| 1 | 1 | 300 | 0.20 |
| 2 | 2 | 540 | 0.45 |
| 3 | 3 | 235 | 120 |
| 4 | 4 | 0.8 | 257 |
| 5 | 5 | 2.2 | 772 |
| 6 | 6 | 0.8 | 753 |
| 7 | 7 | 34 | 864 |
| 8 | 8 | 7.5 | 730 |
| 9 | 9 | 0.7 | 685 |
| 10 | 10 | 1.8 | 643 |
| 11 | 11 | 4.7 | 834 |
| 12 | 12 | NA | 645 |
| 13 | 13 | NA | 92 |
| 14 | 14 | NA | 558 |

### Example 15-26

### Elemental Mercury Sorption (Hg⁰+S-Compound)

Sulfur-containing compounds along with control samples which did not contain sulfur compounds were tested for sorption of elemental mercury are shown in Table 2. The materials were prepared as follows: The materials (Compounds 1 and 2) for Examples 15 and 16 did not contain a sulfur compound and are described above. The material (Compound 15) for Example 17 did not contain a sulfur compound was aluminum oxide, activated powder (purchased from Sigma-Aldrich Corporation, product code 19944-3). The materials (Compounds 4, 5, 7, 8 and 9) for Examples 18-22 contained a sulfur compound and are described above.

The material (Compound 16) for Example 23 [polybissilylpropyltetrasulfide] was prepared by adding 40 grams of Bis[3-(triethoxysilyl)propyl]-tetrasulfide (purchased from Gelest Inc., Morrisville, Pa., product code SIB 1825.0) to 10 grams of ethanol, 2 grams of water and 1 gram of acetic acid. The solution was kept at room temperature and allowed to mix on a rocking table for 3 days to polymerize the bissilylpropyl-tetrasulfide material. The solution was then heated to about 140° C. for about 12 hours to evaporate the solvents thus producing the solid polybissilylpropyltetrasulfide.

The material (Compound 17) for Example 24 was prepared by coating 10 grams of silica gel (described in Example 1) with a solution containing 10 grams of Bis[3-(triethoxysilyl)propyl]-tetrasulfide and 20 grams of methanol, 1 gram of water and 1 gram of acetic acid. The solution was kept at room temperature and allowed to mix on a rocking table for 3 days to polymerize the bissilylpropyl-tetrasulfide on to and in the silica gel. The bissilylpropyl-tetrasulfide coated silica gel powder was filtered and rinsed with methanol then dried at about 140° C. for about 12 hours.

The material (Compound 18) for Example 25 was prepared by coating 10 grams of silica gel (described in Example 1) first with a 20 gram aqueous solution containing 1.3 grams of Na₂(S₄) (synthesized by the method described above) followed by adding a solution containing 1.6 grams of MnCl₂-4H₂O which was dissolved in 50 ml of dI H₂O in order to coat inside and around the silica gel with Mn(S₄). The pH of the suspension of the Mn(S₄)-silica gel was adjusted to 10 by adding a small amount of 5 weight % KOH in water. The solution was filtered and the Mn(S₄)-silica gel powder was rinsed with dI water then dried at about 140° C. for about 12 hours.

The material (Compound 19) for Example 26 was prepared by coating 30 grams of aluminum oxide (described in Example 17) first with a 20 gram aqueous solution containing 1.3 grams of Na₂(S₄) (synthesized by the method described above) followed by adding a solution containing 1.6 grams of MnCl₂-4H₂O which was dissolved in 50 ml of dI H₂O in order to coat inside and around the aluminum oxide with Mn(S₄). The pH of the suspension of the Mn(S₄)-aluminum oxide was adjusted to 10 by adding a small amount of 5 weight % KOH in water. The solution was filtered and the Mn(S₄)— aluminum oxide powder was rinsed with dI water then dried at about 140° C. for about 12 hours.

Testing of the materials for Examples 15-26 was done as follows: A 20 grams of elemental mercury was placed in the bottom of a 3 neck 0.5 liter round bottom flask. Glass beads were then placed in the flask to cover the Hg. A metals-free fiber glass filter paper which was folded was used as a holder wherein approximately 0.2 grams of each material described above for Examples 15-26 was placed inside this fiberglass holder. The flask containing a test sample and elemental mercury was sealed, insulated, and heated to approximately 150° C. for 4 days thus exposing the sample under test to elemental mercury vapor at the elevated temperature. After 4 days, the test sample was removed, it was then placed into a clean flask (no added mercury) and approximately 1 SLPM (standard liters per minute) of nitrogen preheated to about 150° C. was allowed to purge through the flask for 5 days while the flask was being held at approximately 150° C. in order to remove any non-adsorbed mercury from the sample.

As above, the samples were then characterized by ICP-MS (inductively coupled plasma mass spectrometry) to determine the amount of Hg adsorption with each of the materials tested; results are reported in mg of Hg detected per gram of solid Hg:compound adduct. The initial powders (before exposure to Hg) were also characterized by BET-nitrogen absorption to determine their surface area. The results are shown in Table 2.

TABLE 2
Sulfur-containing compounds tested for elemental mercury sorption

| | | | Mercury Adsorbed, |
|---|---|---|---|
| | | Compound Surface | (Hg)/(Hg:compound |
| Example | Compound | Area, m2/gram | adduct), mg/g |
| 15 | 1 | 299 | 0.3 |
| 16 | 2 | 571 | 0.7 |
| 17 | 15 | 166 | 1.3 |
| 18 | 4 | 0.8 | 7.7 |
| 19 | 5 | 2.2 | 115 |
| 20 | 7 | 34 | 310 |
| 21 | 8 | 7.5 | 575 |
| 22 | 9 | 0.7 | 113 |
| 23 | 16 | 0.07 | 410 |
| 24 | 17 | 164 | 258 |
| 25 | 18 | 225 | 161 |
| 26 | 19 | 139 | 33 |

The three control samples (Compounds 1, 2 and 15) contained no sulfur compound. The results show almost no sorption of mercury to the control samples (0.3-1.3 mg Hg/g of Hg:compound adduct). The results also show very high sorption of elemental mercury to all of the compounds which comprised sulfur (Compounds 4, 5, 7-9, and 16-19); the samples absorbed between 7 to 575 mg of Hg per gram of Hg:compound adduct. The sulfur-containing compounds also can be made with a wide variation in surface area of 0.07 m²/g to greater than 200 m²/g.

### Example 27-32

### Elemental Mercury Sorption (Hg⁰+S-Compound) from Simulated Flue Gas

Simulated flue gases were generated by mixing water vapor, mercury, and pre-mixed gases (Airgas, Inc., Radnor, Pa.) containing HCl, SO₂, NO, CO₂, O₂, and N₂. Flow rate through the sample tubes were 750 ml/min, reactor temperature was 150° C., and concentrations of the gasses were as follows: SO₂ 400 ppm, HCl 3 ppm, NO 300 ppm, O₂ 6% by volume, CO₂ 12% by volume, H₂O 10% by volume, elemental Hg)(Hg⁰ was about 16-18 ug/Nm³ (16-18 ppb by weight), balanced with N₂. Samples were evaluated for mercury absorption for about 2 to 3 hours. Concentration of mercury was measured using a PS Analytical, Galahad Mercury Analyzer (Kent, England) with a mercury speciation module for measuring elemental mercury concentration and total mercury concentration.

Samples of materials for examples 27-32 were prepared as follows: The material (Compound 20) for Example 27, Beta-Mn-sulfide, was prepared by first making manganese nitrate solution by adding 5 grams of manganese nitrate solution (50% w/w aqueous, 99%-purity, product code 33340, from Alfa Aesar, Ward Hill, Mass.) to 45 grams of dI H₂O in a 250 ml Erlenmeyer flask, and stirred with magnetic stirrer, followed by slowly adding 20 grams of beta zeolite (product code CP814E, H-form with silica to alumina ratio of 27, from Zeolyst International, Conshohocken, Pa.) with continued stirring. A thio-urea solution was made by dissolving one gram of thio-urea (99% purity, product code 36609 from Alfa Aesar) in 45 grams of dI H₂O in a small beaker, followed by adding this solution slowly to the above zeolite and manganese nitrate mixture while continuously stirring. This resulting mixture was stirred for 16 hours at room temperature (about 22° C.). The mixture was centrifuged to separate the solid and liquid with additional two washing with dI H₂O. The centrifuged cake was dried in air at room temperature for 48 hours. The dried compound was analyzed for Mn (ICP method, 1.81% by weight as oxide-MnO) and S (Leco analysis model SC-632, Leco Corp (St. Joseph, Mich.), 1.2% by weight as S).

The material (Compound 21) for Example 28, ZSM5-Mn-sulfide, was prepared by first making manganese nitrate solution by adding 5 grams of manganese nitrate solution (50% w/w aqueous, 99%-purity from Alfa Aesar) to 45 grams of dI H₂O in a 250 ml Erlenmeyer flask and continuously stirred with magnetic stirrer followed by slowly adding 20 grams of ZSM5 zeolite (CBV3024E, H-form with silica to alumina ratio of 30, from Zeolyst International, Conshohocken, Pa.) with continued stirring. A thio-urea solution was made by dissolving one gram of thio-urea (described above) in 45 grams of dI H₂O in a small beaker, followed by adding this solution slowly to above zeolite and manganese nitrate mixture while continuously stirring. The resulting mixture was stirred for 16 hours at room temperature. The mixture was centrifuged to separate the solid and liquid with additional two washing with dI H₂O. The centrifuged cake was dried in air at room temperature for 48 hours. The dried compound was analyzed for Mn (ICP method, 0.42% by weight as oxide-MnO) and S (Leco analysis, 0.64% by weight as S).

The material (Compound 22) for Example 29, Beta-sulfide, was prepared by first slowly adding 20 grams of beta zeolite (CP814E, H-form with silica to alumina ratio 27 from Zeolyst International, Conshohocken, Pa.) to 45 grams of dI H₂O in a 250 ml Erlenmeyer flask while stirring with a magnetic stirrer. A thio-urea solution was made by dissolving one gram of thio-urea (described above) in 45 grams of dI H₂O in a small beaker, followed by adding this solution slowly to above zeolite and dI H₂O mixture while continuously stirring. This resulting mixture was stirred for 16 hours at room temperature. The mixture was centrifuged to separate the solid and liquid with additional two washing with dI H₂O. The centrifuged cake was dried at room temperature in air for 48 hours. The dried compound was analyzed for S (Leco analysis, 1.7% by weight as S).

The material (Compound 23) for Example 30, ZSM5-sulfide, was prepared by first slowly adding 20 grams of ZSM5 zeolite (CBV3024E, H-form with silica to alumina ratio 30 from Zeolyst International, Conshohocken, Pa.) to 45 grams of dI H₂O in a 250 ml Erlenmeyer flask while stirring with magnetic stirrer. A thio-urea solution was made by dissolving one gram of thio-urea (described above) in 45 grams of dI H₂O in a small beaker, followed by adding this solution slowly to above zeolite and dI H₂O mixture while continuously stirring. This resulting mixture was stirred for 16 hours at room temperature. The mixture was centrifuged to separate the solid and liquid with additional two washing with dI H₂O. The centrifuged cake was dried in air at room temperature for 48 hours. The dried compound was analyzed for S (Leco analysis, 1.71% by weight as S).

The material (Compound 24) for Example 31, Beta-Cu-sulfide, was prepared by first making cupric nitrate solution by adding 0.5 grams of copper (II) nitrate powder (98%-purity from Sigma-Aldrich, St. Louis, Mo., product code 223395) to 45 grams of dl H₂O in a 250 ml Erlenmeyer flask and continuously stirred with magnetic stirrer followed by slowly adding 20 grams of beta zeolite (CP814E, H-form with silica to alumina ratio of 27 from Zeolyst International, Conshohocken, Pa.) while continuously stirring. A thio-urea solution was made by dissolving 0.5 gram of thio-urea (described above) in 45 grams of dI H₂O in a small beaker, followed by adding this solution slowly to above zeolite and copper-II nitrate mixture while continuously stirring. This resulting mixture was stirred for 16 hours at room temperature. The mixture was centrifuged to separate the solid and liquid with additional two washing with dI H₂O. The centrifuged cake was dried in air at room temperature for 48 hours. The dried compound was analyzed for Cu (ICP method, 0.49% by weight as oxide-CuO) and S (Leco analysis, 1.5% by weight as S).

The material (Compound 25) for Example 32, ZSM5-Cu-sulfide, was prepared by first making cupric nitrate solution by adding 0.5 grams of copper (II) nitrate powder (described above) to 45 grams of dI H₂O in a 250 ml Erlenmeyer flask and continuously stirred with magnetic stirrer followed by slowly adding 20 grams of beta zeolite (CBV3024E, H-form with silica to alumina ratio of 30 from Zeolyst International, Conshohocken, Pa.) while continuously stirring. A thio-urea solution was made by dissolving 0.5 gram of thio-urea (described above) in 45 grams of dI H₂O in a small beaker, followed by adding this solution slowly to above zeolite and copper-II nitrate mixture while continuously stirring. This resulting mixture was stirred for 16 hours at room temperature. The mixture was centrifuged to separate the solid and liquid with additional two washing with dI H₂O. The centrifuged cake was dried in air for 48 hours. The dried compound was analyzed for Cu (ICP method, 0.78% by weight as oxide-CuO) and S (Leco analysis, 2.6% by weight as S).

Samples for testing for examples 27-32 were prepared as follows: Quartz tubing purchased from National Scientific Co., Inc. (Quakertown Pa.), as 7.00 mm ID×9.50 mm OD tubing. It was cut into 15 cm lengths with an indentation flame worked about 3 cm from one end. The indentation protruded approximately half way through the tube and acted as a stopper for the quartz wool and powder sample packed in the tube. Each end of the tube was flame polished resulting in a smooth surface. Next, quartz wool (Grace Davidson Discovery Sciences, Deerfield, Ill., product code 4033) was pushed into the tube using a disposable wooden rod; sufficient wool was used to occupy about 2 cm length of the tube. The tubes were then filled with a 0.10 grams of powder (e.g., compounds 20-25, mercury absorber to be tested) dispersed with 1.0 grams of granulated cordierite (−35/+140 mesh, 50% porosity by volume). Quartz wool was then packed on top of the cordierite/zeolite material to within about 1 cm of the end of the tube. Samples had less than 3 psi pressure drop while flowing 750 ml/minute of N₂ gas.

TABLE 3
Sulfur-containing compounds tested for elemental
mercury sorption from simulated flue gas

| | | % Mercury Adsorbed as a function of |
|---|---|---|
| Example | Compound | inlet Hg concentration |
| 27 | 20 | 64 |
| 28 | 21 | 45 |
| 29 | 22 | 45 |
| 30 | 23 | 52 |
| 31 | 24 | 95 |
| 32 | 25 | 70 |

Results in Table 3 show that the sulfur compounds complexed with zeolites were effective in removing mercury (elemental Hg and oxidized Hg) from a simulated flue gas stream. The sulfur-containing compounds disclosed herein may, in accordance with the invention, be distributed throughout a flow-through substrate structure, such as a honeycomb, which may be used for the capture of heavy metals such as mercury, including the capture of heavy metals from a fluid stream.

### Examples 33-50

### Honeycomb Substrate Coated with a Sulfur-Containing Compound

The sulfur-containing compounds disclosed herein were coated onto cordierite honeycomb substrates as follows. Example 33: The coated material cordierite honeycomb for Sample 33, ZSM5-Mn-sulfide: corderite honeycomb was prepared as follows. First zeolite slurry was made by adding 30 grams colloidal alumina (product code AL20 from Nyacol Nano Technologies, Inc., Ashland, Mass., 20% Al2O3, pH˜3.8) to 75 grams of dI H₂O followed by adding 60 grams of ZSM5 zeolite (CBV3002, H-form, with silica to alumina ratio of 300, from Zeolyst International, Conshohocken, Pa.). The resulting slurry was blended in small blender for two minutes in two intervals yielding well mixed slurry. The slurry was washcoated onto cordierite honeycomb substrates (65 cells per square inch with a wall thickness of 0.017 inches, with 50% porosity as measured by mercury porosimetry method) using vacuum coating technique as described below. Cordierite sample (2 inch diameter by 3.5″ length) was connected to vacuum at top section, followed by inserting lower half section into a cup with calculated amount (22 grams, needed to coat half length of honeycomb) of washcoating slurry. Vacuum pulls the slurry up and coats the surface by slip-casting process. The sample was taken out and turned upside down and passed under air knife to remove any excess slurry in the channels. This vacuum coating was repeated on the other half. After second coating the sample was air dried vertically under an air fan. Coating was repeated with second layer to achieve good quality coating and weight loading. Coated sample was dried in oven and fired at 550° C. for 5 hours. A smaller size (2 inch diameter by 1 inch length) of this fired zeolite coated honeycomb sample was loaded with manganese and thio-urea as described here. Manganese nitrate solution made by adding 2 grams of manganese nitrate solution (described above) to 150 grams of dI H₂O in a 400 ml beaker, a perforated plastic ring (¾ inch tall) was used to support the honeycomb substrate and hold a magnetic stirrer in the center of the plastic ring. This assembly allowed a coating solution to flow through the substrate. The honeycomb sample was placed on the top of the ring followed by adding thio-urea solution (0.5 gram thio-urea in 45 gram of dI H₂O) slowly to the beaker containing the honeycomb; stirring was continued for 16 hours. The honeycomb sample was taken and washed twice with dI H₂O to remove excess metal ions and thio-urea form the surface. The sample was air dried at room temperature for 1 day.

Other zeolites, including mordenite, beta (with two different silica/alumina ratios), and ZSM5 (high silica/alumina ratio) were coated using the method as described in example 33 using slurry formulation given following table.

TABLE 4
Slurry formulations for washcoating a substrate with a zeolite compound.

| Slurry | | SiO₂/ | Zeolite | Nyacol | dI- | Total | |
|---|---|---|---|---|---|---|---|
| formulation | | A₂O₃ | Weight | AL20 | H₂O | slurry | Solid |
| identification | Zeolite | ratio | (g) | (g) | (g) | wt (g) | fraction |
| A | ZSM5, Zeolyst | 1000 | 60 | 30 | 75 | 165 | 0.4 |
| | International, | | | | | | |
| | CBV-10002 | | | | | | |
| B | ZSM5, Zeolyst | 300 | 60 | 30 | 75 | 165 | 0.4 |
| | International, | | | | | | |
| | CBV3002 | | | | | | |
| C | Mordenite, | 200 | 110 | 55 | 138 | 303 | 0.4 |
| | Tosoh USA | | | | | | |
| | Corp., Grove | | | | | | |
| | City, OH, | | | | | | |
| | HSZ690- | | | | | | |
| D | Beta, Zeolyst | 200 | 60 | 30 | 230 | 320 | 0.21 |
| | International, | | | | | | |
| | CP811B | | | | | | |
| E | Beta, Tosoh | 37 | 60 | 30 | 230 | 320 | 0.21 |
| | USA Corp., | | | | | | |
| | HSZ930 | | | | | | |

These coated samples were dried in oven and fired at 550° C. for 5 hours. These fired zeolite coated honeycomb samples (2 inch diameter by 1 inch length) were loaded with either manganese (II) and thio-urea, or copper (II) and thio-urea, or thio-urea only using the method as described in example 33. Detailed composition of loading process for different samples (Examples 34-47) are given in following table.

TABLE 5
Detailed composition of sulfur-compound and metal
ion loading on zeolite washcoated substrates.

| Sample number | Zeolite, sulfur-compound and metal ion compositions for coating | | | | | | |
|---|---|---|---|---|---|---|---|
| of zeolite coated | honeycomb substrates | | | | | | |
| honeycomb with | | | Exchange | dI- | Thio- | dI- | Total |
| sulfur-compound | Zeolite | Exchange salt | material | H₂O | urea | H₂O | wt |
| and metal ion | material | material | (g) | (g) | (g) | (g) | (g) |
| 33 | ZSM5, | Mn—(NO₃)₂ | 2 | 150 | 0.50 | 45 | 197.5 |
| | Zeolyst | 50/50solution | | | | | |
| | CBV-10002 | | | | | | |
| 34 | ZSM5, | Cu—(NO₃)₂ | 0.5 | 150 | 0.50 | 45 | 196 |
| | Zeolyst | | | | | | |
| | CBV-10002 | | | | | | |
| 35 | ZSM5, | None | | 150 | 0.50 | 45 | 195.5 |
| | Zeolyst | | | | | | |
| | CBV-10002 | | | | | | |
| 36 | ZSM5, | Mn—(NO₃)₂ | 2 | 150 | 0.50 | 45 | 197.5 |
| | Zeolyst | 50/50solution | | | | | |
| | CBV3002 | | | | | | |
| 37 | ZSM5, | Cu—(NO₃)₂ | 0.5 | 150 | 0.50 | 45 | 196 |
| | Zeolyst | | | | | | |
| | CBV3002 | | | | | | |
| 38 | ZSM5, | None | | 150 | 0.50 | 45 | 195.5 |
| | Zeolyst | | | | | | |
| | CBV3002 | | | | | | |
| 39 | Mordenite, | Mn—(NO₃)₂ | 2 | 150 | 0.50 | 45 | 197.5 |
| | Tosoh - | 50/50solution | | | | | |
| | HSZ690 | | | | | | |
| 40 | Mordenite, | Cu—(NO₃)₂ | 0.5 | 150 | 0.50 | 45 | 196 |
| | Tosoh - | | | | | | |
| | HSZ690 | | | | | | |
| 41 | Mordenite, | None | | 150 | 0.50 | 45 | 195.5 |
| | Tosoh - | | | | | | |
| | HSZ690 | | | | | | |
| 42 | Beta, | Mn—(NO₃)₂ | 2 | 150 | 0.50 | 45 | 197.5 |
| | Zeolyst- | 50/50solution | | | | | |
| | CP811B | | | | | | |
| 43 | Beta, | Cu—(NO₃)₂ | 0.5 | 150 | 0.50 | 45 | 196 |
| | Zeolyst- | | | | | | |
| | CP811B | | | | | | |
| 44 | Beta, | None | | 150 | 0.50 | 45 | 195.5 |
| | Zeolyst- | | | | | | |
| | CP811B | | | | | | |
| 45 | Beta, Tosoh | Mn—(NO₃)₂ | 2 | 150 | 0.50 | 45 | 197.5 |
| | HSZ930 | 50/50solution | | | | | |
| 46 | Beta, Tosoh | Cu—(NO₃)₂ | 0.5 | 150 | 0.50 | 45 | 196 |
| | HSZ930 | | | | | | |
| 47 | Beta, Tosoh | None | | 150 | 0.50 | 45 | 195.5 |
| | HSZ930 | | | | | | |

Sulfur-containing compounds coated on a flow through substrate (honeycomb) were tested for elemental mercury sorption from simulated flue gas as described above. Samples of the coated honeycombs from examples 36 and 38 were prepared by cutting sections of the honeycomb approximately 6 mm in diameter along the length of the channels. Quartz tubing described above (7.00 mm ID×9.50 mm OD tubing) was cut into 15 cm lengths with an indentation flame worked about 3 cm from one end. The indentation protruded approximately half way through the tube and acted as a stopper for the quartz wool and honeycomb sample placed in the tube. Each end of the tube was flame polished resulting in a smooth surface. Next, quartz wool (Grace Davidson Discovery Sciences, Deerfield, Ill., product code 4033) was pushed into the tube using a disposable wooden rod; sufficient wool was used to occupy about 2 cm length of the tube. Next, sections of the coated honeycomb (about 1.2 and 1.4 grams for examples 36 and 38 respectively; this was equivalent to about 2 cm³ outside dimensional volume) were placed in the tube. Quartz wool was then packed on top of the honeycomb to within about 1 cm of the end of the tube. Samples had less than 3 psi pressure drop while flowing 750 ml/minute of N₂ gas. Samples were tested for 2-3 hours using elemental mercury sorption from simulated flue gas testing. The results for examples 36 and 38 showed that they removed approximately 84 and 57 percent respectively of mercury (elemental and oxidized) from the simulated flue gas stream.

Additional samples (Examples 48-50) were prepared as follows; Sulfur-containing compounds disclosed herein were coated onto cordierite honeycomb substrates as follows. The as-received cordierite honeycomb substrates were approximately 2 inch diameter by 3 inch long (about 5 cm by 7.5 cm) having open channels along the 3-inch long length. The cell geometry was square and the substrates had about 95 cells per square inch (about 15 cells/cm²) with a wall thickness of about 0.019 inches (about 0.5 mm). Porosity for these honeycomb substrates was determined using a Micromeritics Autopore 1V 9520 Mercury Porosimeter (Micromeritics Instrument Corporation, Norcross, Ga.); these substrates had about 64% by volume porosity with a mean pore diameter of about 24 microns. The as-received honeycomb substrates weighed about 45 grams.

The sulfur-containing coatings used for these substrates were as follows. A coating solution of the material (Compound 8b) for Example 48 [Mn(S₄), manganese tetrasulfide] was prepared in a similar manner to Compound 8 described above. Mn(S₄), manganese tetrasulfide, nano-colloid suspension was prepared by first reacting 100 grams of Na₂S-9H₂O with 40 grams of elemental sulfur plus 650 ml of dI H₂O and stirring at approximately 22° C. for 12 hours in order to produce Na₂(S₄) in solution. 45 grams of MnCl₂-4H₂O was dissolved in about 100 ml of dI H₂O then added to the Na₂(S₄) solution while mixing using an ultrasonic bath to produce Mn(S₄) nano-colloid suspension. The pH of the Mn(S₄) nano-colloid suspension was adjusted to 10 by adding a small amount of 5 weight % KOH in water. This suspension was used to coat the honeycomb substrates. A coating solution of the material (Compound 16) for Example 49 [polybissilylpropyltetrasulfide] was prepared by adding 400 grams of Bis[3-(triethoxysilyl)propyl]-tetrasulfide to 100 grams of ethanol, 20 grams of water and 10 gram of acetic acid. The solution was kept at room temperature and allowed to mix on a rocking table for 1 day to partially polymerize the bissilylpropyl-tetrasulfide material. This solution was used to coat the honeycomb substrates. A coating solution of the material (Compound 20) for Example 50 [elemental sulfur, purchased from Sigma-Aldrich as described above] was prepared by adding 200 grams of sulfur powder to 460 grams of carbon disulfide (CS₂). The solution was kept at room temperature and allowed to mix on a rocking table for 1 day to partially dissolve and disperse the sulfur powder in suspension. This solution was used to coat the honeycomb substrates.

The above sulfur-containing coating solutions for examples 48-50 were placed in individual beakers, respectively, and each stirred with a Teflon coated stir bar. This was done to maintain the coating material in suspension (in the case of solutions containing solids). The honeycombs were immersed into the coating solutions then removed and the excess coating was gently blown out of the cells with nitrogen gas. The coated honeycomb substrate for Example 48 was allowed to dry in air for about 2 hours at about 140° C. then cooled to room temperature, rinsed with dI water, the excess water was removed by blowing out the cells with N₂ gas then the sample was dried again for about 3-6 additional hours at about 140° C. then cooled to room temperature and weighed. The coated honeycomb weighed about 50 grams showing the honeycomb comprised about 5 grams (about 11 weight percent) of Mn(S₄) sulfur-containing coating. The coated honeycomb substrate for Example 49 was allowed to dry in air for several days at room temperature then the sample was heated for about 1 day at about 140° C. then cooled to room temperature and weighed. The coated honeycomb weighed about 70 grams showing the honeycomb comprised about 25 grams (about 55 weight percent) of polybissilylpropyltetrasulfide sulfur-containing coating. The coated honeycomb substrate for Example 50 was allowed to dry in air for about 12 hours at room temperature then the sample was heated for about 2 hours at about 140° C. then cooled to room temperature and weighed. The coated honeycomb weighed about 63 grams showing the honeycomb comprised about 18 grams (about 40 weight percent) of elemental sulfur coating.

The sulfur-containing compounds disclosed herein may, in accordance with the invention, be distributed throughout a flow-through substrate. For example, the materials disclosed as coating in Examples 33-50 could instead themselves be formed into flow-through substrates having a sulfur-containing compound distributed throughout. Flow-through substrates, such as honeycombs may be used for the capture of heavy metals such as mercury, including the capture of heavy metals from a fluid stream.

It should be understood that while the invention has been described in detail with respect to certain illustrative embodiments thereof, it should not be considered limited to such, as numerous modifications are possible without departing from the broad spirit and scope of the invention as defined in the appended claims.

We claim:

1. A flow-through substrate, which comprises a sulfur-containing compound distributed throughout the flow-through substrate structure;
wherein the sulfur-containing compound is selected from 1) a non-elemental and non-metal sulfide sulfur compound; 2) a polysulfide; and 3) an organic mono- or polysulfide;
wherein the flow-through substrate is essentially free of activated carbon; and
wherein the flow-through substrate structure comprises at least 50 wt % of glass, ceramic, inorganic cement, or glass ceramic.

2. A flow-through substrate of claim 1, wherein the flow-through substrate comprises an inorganic cement.

3. A flow-through substrate of claim 2, wherein the inorganic cement comprises an oxide, sulfate, carbonate, or phosphate of a metal.

4. A flow-through substrate of claim 1, wherein the flow-through substrate comprises a polymer.

5. A flow-through substrate of claim 1, wherein the flow-through substrate comprises a surface having a surface area of 100 m²/g or more.

6. A flow-through substrate of claim 1, wherein the sulfur-containing compound is a non elemental and non-metal sulfide sulfur compound.

7. A flow-through substrate of claim 1, wherein the sulfur-containing compound is a metal polysulfide.

8. A flow-through substrate of claim 1, wherein the sulfur-containing compound is an organic mono- or polysulfide.

9. A flow-through substrate of claim 1, which further comprises elemental sulfur.

10. A flow-through substrate of claim 1, wherein the sulfur-containing compound is a silane, a thio-carbamate, a thiocyanurate, a thio- or polythioolefin, cysteine, cystine, or mercaptosuccinic acid.

11. A flow-through substrate of claim 1, which comprises an inorganic cement or an organic polymer, wherein at least a portion of the sulfur-containing compound is chemically bound to at least a portion of the inorganic cement or organic polymer.

12. A process for making a flow-through substrate of claim 1, which comprises:
mixing the sulfur-containing compound with batch mixture material to provide a sulfur compound-containing batch mixture; and
forming the sulfur compound-containing batch mixture into a flow-through substrate.

13. A process of claim 12, wherein the batch mixture material comprises an oxide, sulfate, carbonate, or phosphate of a metal.

14. A process of claim 12, wherein the batch mixture material comprises a polymer.

15. A process of claim 12, which comprises forming the sulfur compound-containing batch mixture into a honeycomb shape by extrusion.

16. A process of claim 12, which further comprises drying the honeycomb.

17. A method for removing a heavy metal from a fluid, which comprises contacting a fluid comprising a heavy metal with a flow-through substrate of claim 1.

18. A method of claim 17, wherein the fluid comprises a coal combustion flue gas or coal gasification syngas.

19. A method of claim 17, which comprises removing from the fluid a heavy metal selected from cadmium, chromium, lead, barium, beryllium, nickel, cobalt, vanadium, zinc, copper, mercury, manganese, antimony, silver, thallium, arsenic and selenium.

20. A method of claim 19, wherein the fluid comprises a liquid.

21. A method of claim 19, which comprises contacting the fluid with the flow-through substrate by passing the fluid through inner passageways extending from an inlet end to an outlet end of the flow-through substrate.

22. A power plant comprising:
a coal combustion or coal gasification unit;
a flow-through substrate of claim 1; and
a passageway adapted to convey a coal combustion flue gas or syngas from the coal combustion or gasification unit to the flow-through substrate.

23. A flow-through substrate, which comprises a sulfur-containing compound distributed throughout the flow-through substrate structure;
wherein the sulfur-containing compound is selected from 1) a metal polysulfide and 2) an organic mono- or poly-sulfide.

24. A flow-through substrate of claim 23, wherein the flow-through substrate comprises a polymer.

25. A flow-through substrate of claim 23, wherein the sulfur-containing compound is a metal polysulfide.

26. A flow-through substrate of claim 23, wherein the sulfur-containing compound is an organic mono- or poly-sulfide.

27. A process for making a flow-through substrate of claim 23, which comprises:
mixing the sulfur-containing compound with batch mixture material to provide a sulfur compound-containing batch mixture; and
forming the sulfur compound-containing batch mixture into a flow-through substrate.

28. A process of claim 27, wherein the batch mixture material comprises an organic polymer.

29. A method for removing a heavy metal from a fluid, which comprises contacting a fluid comprising a heavy metal with a flow-through substrate of claim 23.

30. A flow-through substrate, which comprises a sulfur-containing compound distributed throughout the flow-through substrate structure;
wherein the flow-through substrate comprises no metal mono-sulfide, or, comprises less than 30 wt % metal monosulfide;
wherein the flow-through substrate is essentially free of activated carbon; and
wherein the flow-through substrate structure comprises at least 50 wt % of glass, ceramic, inorganic cement, or glass ceramic.

31. A flow-through substrate of claim 30, which does not comprise a metal mono-sulfide.

32. A flow-through substrate of claim 30, wherein the sulfur-containing compound consists essentially of elemental sulfur.

33. A flow-through substrate of claim 30, which comprises at least 50 wt % of an inorganic cement.

34. A flow-through substrate of claim 30 consisting essentially of elemental sulfur and an inorganic cement.

35. A flow-through substrate of claim 1, wherein the flow-through substrate is a honeycomb.

36. A flow-through substrate of claim 23, wherein the flow-through substrate is a honeycomb.

37. A flow-through substrate of claim 30, wherein the flow-through substrate is a honeycomb.
